(19) United States
(12) Patent Application Publication
(10) Pub. No.: US 2014/0021125 A1
(43) Pub. Date: Jan. 23, 2014

(54) SELF-CLEANING SUCTION FILTER

(71) Applicants: Deng Hong Luo, Heng Yang (CN); Wen Bin Liu, Bao Jing (CN); Yong Huang, Heng Yang (CN); Qing Huang, Shenzhen (CN)

(72) Inventors: Deng Hong Luo, Heng Yang (CN); Wen Bin Liu, Bao Jing (CN); Yong Huang, Heng Yang (CN); Qing Huang, Shenzhen (CN)

(73) Assignee: Dan Lin, Shenzhen (CN)

(21) Appl. No.: 13/551,826

(22) Filed: Jul. 18, 2012

(51) Int. Cl. B01D 29/62

(52) U.S. Cl. 210/332

(57) ABSTRACT

The present invention provides a self-cleaning suction filter including a filter mechanism and a sewage suction assembly. The sewage suction assembly is rotatably arranged at the center of a fine strainer and communicated with a sewage discharge cavity through a sewage suction pipe, and the sewage suction pipe is spacedly and fixedly provided with a plurality of “T”-shape suction nozzles for suctioning deposits on the inner wall of the fine strainer. The self-cleaning suction filter further includes: a sand collection cavity arranged at the tail of the fine filter cavity and communicated with the fine filter cavity; and the coarse filter cavity, the fine filter cavity, and the sand collection cavity descend in height. Water are automatically collected in the sand collection cavity and discharged in time, thereby ensuring the stable filter function after the filter is used for a long time.

### BACKGROUND OF THE INVENTION

1. Field of the Invention

The present invention relates to the apparatus in the field of precise filter in water processing, and in particular, to a self-cleaning filter applicable to the scenario where the water quality condition is harsh, the diameter of particles in the contaminants in a water system, and there is a low requirement for the system pressure.

2. Background

Chinese patent No. ZL 200810217079.8 filed on Oct. 24, 2008 and issued on Mar. 23, 2011 with publication No. CN 101402010 B has disclosed an electrically-controlled washing apparatus for self-cleaning filter. The structure of the filter for real-time purification of circulating water for industrial use is as shown in FIG. 1. Specifically, raw water is led into a coarse filter cavity 102 from a water inlet 101, contaminants with large particles in the raw water are filtered and intercepted by a coarse strainer 103, the raw water then flows into a fine filter cavity 104 and further filtered by a fine strainer 105, and then the purified water is led out from a water outlet 106.

After a period of filtering, a layer of contaminants and dirt is generally deposited on the inner wall of the fine strainer 105, producing an increasing pressure difference between the interior and exterior of the fine strainer 105. If this pressure difference is too large, the filter speed may be affected. Accordingly, a sewage suction assembly 6 is arranged along the direction of the axial center inside a cylinder fine filter cavity 104 enclosed by the fine strainer; a plurality of suction nozzles 61 are spacedly arranged on the sewage suction assembly 6. The sewage suction assembly 6 drives a coupler 9 arranged on a spiral rod 8 by using a rotation drive motor 7. During backwashing, i.e., sewage discharging, a sewage discharge valve 11 automatically switches on, and the sewage suction assembly 6 translates spirally towards the direction of the sewage discharge cavity 107 under the drive of the rotation drive motor 7 to enable the suction nozzles 61 to operate synchronously. When the sewage discharge valve 11 switches on, the pressure inside the sewage discharge cavity 107 communicated with the atmosphere air sharply decreases, and the sewage discharge cavity 107 is communicated with the sewage suction assembly 6 and the suction nozzles 61, thereby causing a synchronous sharp decrease to the pressure as compared with the pressure inside the fine filter cavity. In this way, thorough suctioning and cleaning of the contaminants attached on the inner wall of the fine strainer is implemented by using the suction nozzles 61, and the contaminants are suctioned by the sewage suction assembly 6 to the sewage discharge cavity 107 and then discharged from the sewage discharge valve 11, implementing cleaning of the filter. During such backwashing process, the water flow is not interrupted, and therefore, continuous and automatic working is implemented.

However, when the self-cleaning filter using the suction mode is used to suction the sewage and contaminants attached on the inner wall of the fine strainer, the sewage and contaminants having an outer diameter larger than the spacing between the suction nozzles and the meshes of the fine strainer fail to be effectively removed. In addition, the sewage and contaminants having large particles generally causes blocking and jamming effect on the sewage suction device and the fine strainer. Consequently, the sewage suction and filtering effects are degraded and the stability of the normal filtering function of the filter cannot be ensured.

In addition, the suction force needs to be generated by the suction nozzles depending on the pressure of the water system. To be specific, the suction force of the suction nozzles depends on the pressure difference between the water pressure inside the water system and the atmospheric pressure. In the case where the water system has a low pressure, the suction nozzles generates a suction force insufficient to effectively remote the sewage and contaminants strongly attached on the fine strainer. When the filter is used for a long time, some contaminants are formed on the surface of the fine strainer, affecting the filtering efficiency of the fine strainer, and even totally blocking the meshes of the fine strainer and rendering no filtering function to the fine strainer.

### SUMMARY OF THE INVENTION

One object of the present invention is to provide a self-cleaning suction filter to improve the technical defect that the water quality condition of the raw water is complicated and the large-particle sewage in the water cannot be effectively collected or removed.

Another objective of the present invention is to provide a self-cleaning suction filter, which, when being used under low pressure of the raw water system, is still capable of effectively removing the sewage strongly attached on the fine strainer.

To achieve the above objectives, the present invention provides a self-cleaning suction filter, including a filter mechanism and a sewage suction assembly; where the filter mechanism includes a water inlet, a coarse strainer, a coarse filter cavity, a fine filter cavity, a fine strainer, and a water outlet; where raw water is led in from the water inlet, flows through the coarse strainer into the coarse filter cavity, enters the fine filter cavity from the coarse filter cavity, and is led out from the water outlet after a secondary filter by the fine strainer; the sewage suction assembly is rotatably arranged at the center of the fine strainer and communicated with a sewage discharge cavity through a sewage suction pipe, and the sewage suction pipe is spacedly provided with a plurality of suction nozzles for suctioning deposits on the inner wall of the fine strainer; where the self-cleaning suction filter further includes: a sand collection cavity arranged at the tail of the fine filter cavity and communicated with the fine filter cavity; and the coarse filter cavity, the fine filter cavity, and the sand collection cavity are descending in height. Specifically, a support for increasing the height may be arranged at the bottom at one end of the filter closed to the coarse filter cavity.

The filter further includes a suction pump. The suction pump is arranged outside of the filter and the suction pipe of the suction pump is communicated with the sewage discharge cavity.

The sewage suction assembly rotates under the drive of a transmission rod driven by a rotation motor, the suction nozzles are oblong suction nozzles and communicated with the sewage suction pipe through a nozzle support rod, and the sum of the lengths of all suction nozzles is larger than the total length of the fine filter cavity.

The fine strainer is in a cylinder structure without end caps on the two ends. One end of the fine strainer is communicated with the coarse strainer, and the other end of the fine strainer is communicated with the sand collection cavity. The sewage suction assembly is arranged at the central axis of the cylinder fine strainer.

According to the present invention, based on the original mechanism, a sand collection cavity is added at the tail of the fine filter cavity, and the coarse filter cavity, the fine filter cavity, and the sand collection cavity descend in height to form a tilt angle structure with a higher front and lower rear. The sewage and contaminants having large particles, especially with the outer diameter larger than the spacing between the suction nozzles and the meshes of the fine strainer, in the raw water, settle down and are collected in the sand collection cavity during filtering due to their own weight and the guiding force of the water flow. In this way, the blocking and jamming effect caused by the large-particle sewage and contaminants to the fine strainer and the suction nozzles is mitigated, and the normal use of the function of the filter is improved or stabilized. The additionally set suction pump is capable of obviously improving the pressure of the suction nozzles, enhances the suction force of the suction nozzles, and further improves the cleaning effect to the fine strainer. In this way, it is ensured that when the filter is used for a long time, the sewage suction and discharge ability is still reliable, i.e., having a stable filtering function. The filter is especially applicable to the fields of agricultural micro irrigation system, drip irrigation by the snow water, dust-proofing of the coal mine water system.

### BRIEF DESCRIPTION OF THE DRAWINGS

FIG. 1 is a schematic diagram of the internal structure of a common circulating water filter;

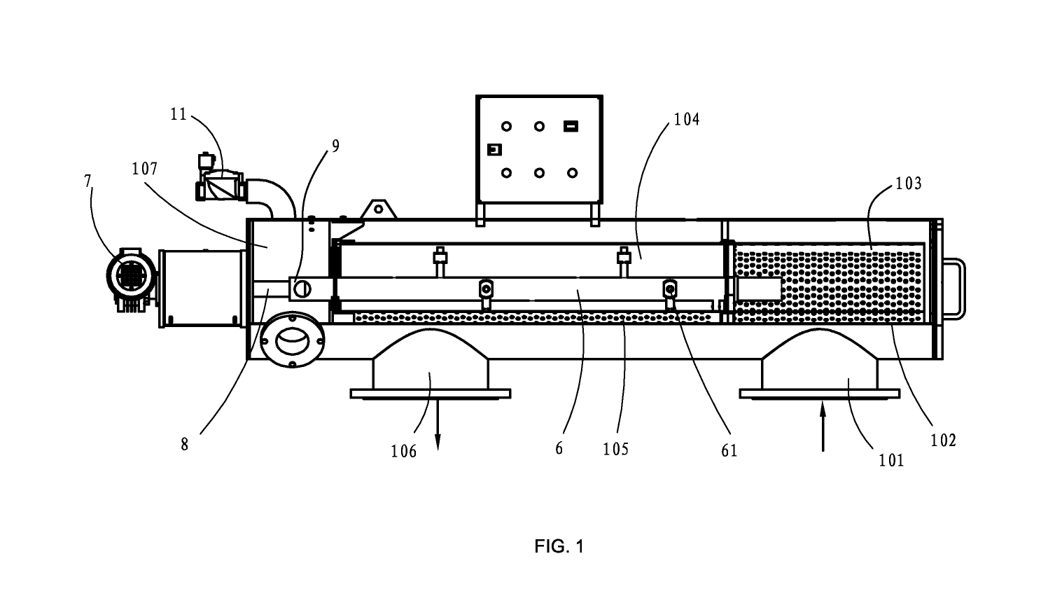

FIG. 2 is a schematic structural diagram of a self-cleaning suction filter according to the present invention;

FIG. 3 is a component diagram of the external structure of the self-cleaning suction filter illustrated in FIG. 2;

FIG. 4 is a schematic diagram of the strainer structure of the self-cleaning suction filter illustrated in FIG. 2; and

FIG. 5 is a schematic structural diagram of a sewage suction assembly of the self-cleaning filter illustrated in FIG. 2.

### DETAILED DESCRIPTION OF THE EMBODIMENTS

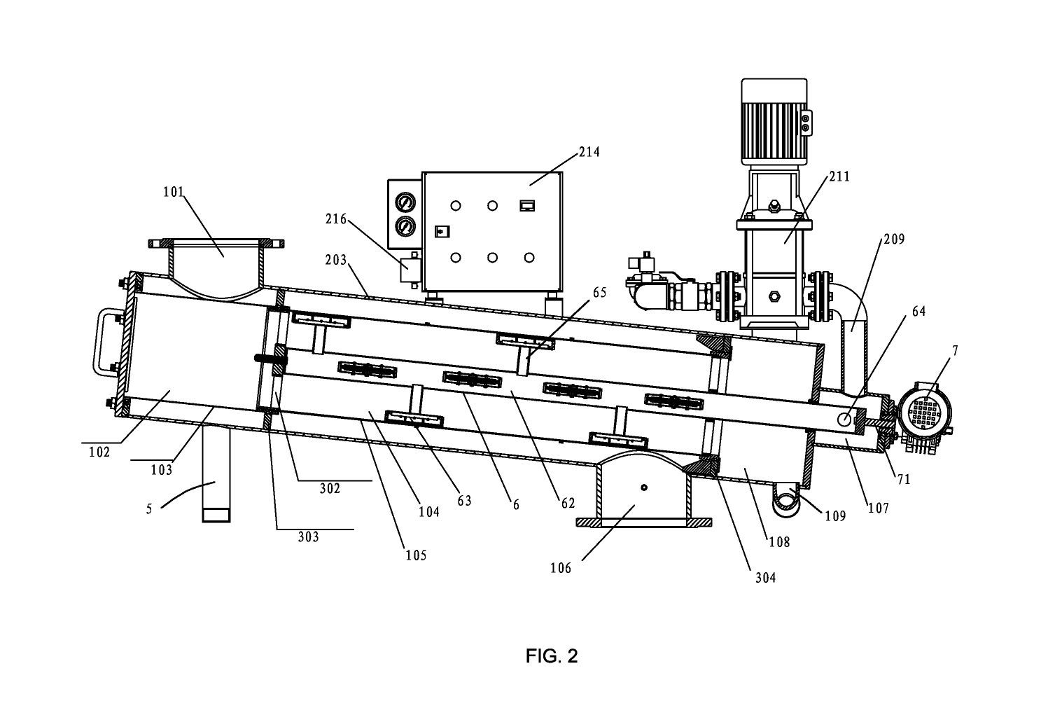

With reference to FIGS. 2, 3, 4, and 5, preferable embodiments of the present invention provide a self-cleaning suction filter, including a filter mechanism and a sewage suction assembly 6. The filter mechanism includes a water inlet 101, a coarse strainer 102, a coarse filter cavity 103, a fine filter cavity 104, a fine strainer 105, and a water outlet 106. Raw water is led in from the water inlet 101, flows through the coarse strainer 102 into the coarse filter cavity 103, enters the fine filter cavity 104 from the coarse filter cavity 103, and is led out from the water outlet 106 after a secondary filter by the fine strainer 105, which are the common structure or filter principles. The sewage suction assembly 6 is rotatably arranged at the center of the fine strainer 105 in common mode, and a sewage suction pipe 62 of the sewage suction assembly 6 is communicated with a sewage discharge cavity 107 through a sewage discharge pipe port 64. The sewage suction pipe 62 is isolated from the water flowing in the filter cavity by using its two pipe wall, and the sewage suction pipe 62 is spacedly provided with a plurality of suction nozzles 63 for suctioning deposits on the inner wall of the fine strainer 105. The spacing between the suction nozzles and the inner wall of the fine strainer is generally controlled within 2 mm so that during backwashing, the sewage and contaminants deposit on the inner wall of the fine strainer are completely suctioned away from the inner wall of the fine strainer, delivered to the sewage discharge cavity through the sewage suction pipe 62 and the sewage discharge pipe port 64, and then discharged by the suction pump 211, thereby achieves backwashing of the fine strainer.

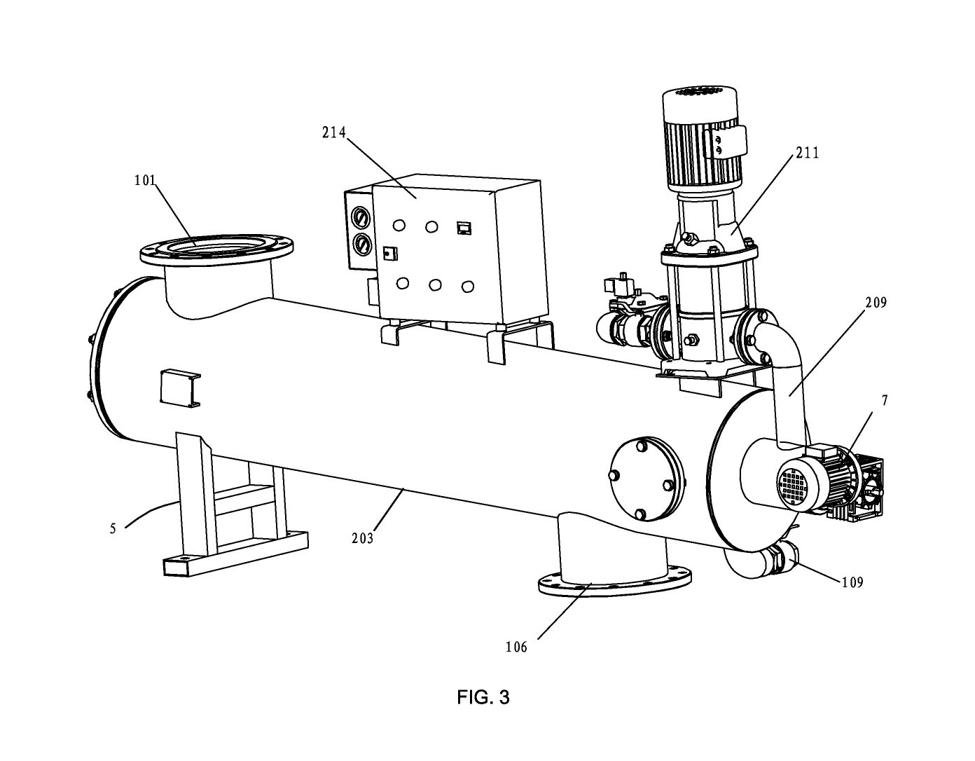

The major difference between the present invention and the prior art lies in that the filter of the present invention further includes a sand collection cavity 108 arranged at the tail of the fine filter cavity 104 and communicated with the fine filter cavity. The coarse filter cavity, the fine filter cavity, and the sand collection cavity are descending in height. In practice, the simplest way is illustrated in FIG. 2 and FIG. 3. A support 5 is arranged at the bottom at one end of the coarse filter cavity close to the filter, supporting externally and increasing the height of the end of the filter closed to the coarse filter cavity so that the coarse filter cavity, the fine filter cavity, and the sand collection cavity descend in height. The structures of other parts of the filter do not change. In this way, the central axis of the coarse filter cavity, the fine filter cavity, and the sand collection cavity forms a specific tilt angle with the horizontal plane so that the sewage and contaminants having large particles and hard to be filtered and suctioned in the raw water settle down automatically while flowing with the water flow and then are collected in the sand collection cavity 108. Definitely, it is also applicable when the coarse filter cavity, the fine filter cavity, and the sand collection cavity descend in height to form a specific tilt angle with the horizontal plane so that the large and heavy sewage and contaminants settle down and are collected in other common mode having the equivalent function or effect.

Setting the sand collection cavity 108 is mainly directed to enabling the sewage and contaminants having large particles, especially with the outer diameter larger than the spacing between the suction nozzles and the meshes of the fine strainer, in the raw water to settle down and be collected in the sand collection cavity during filtering due to their own weight and the guiding force of the water flow. In this way, the blocking and jamming effect caused by the large-particle sewage and contaminants to the fine strainer and the suction nozzles is mitigated, and the normal use of the function of the filter is improved or stabilized.

The sand discharge port of the sand collection cavity 108 is provided with a sand discharge valve 109. When much sewage and many contaminants having large particles are collected in the sand collection cavity, they are discharged directly by opening the sand discharge valve 109, thereby ensuring the sewage discharge function and stability of the filter function.

To accommodate filtering of the low-pressure raw water, and increase the suction force of the suction nozzles on the sewage suction assembly during backwashing, the present invention also provides a suction pump 211. The suction pump is arranged outside a filter housing 203. A suction pipe 209 of the suction pump is communicated with the sewage discharge cavity 107. In this way, during backwashing of the inner wall of the fine strainer, the suction force of the suction nozzles communicated with the suction pump is enhanced by using the negative pressure generated by the suction pump. In the prior art, the suction force of the suction nozzles mainly depends on the suction force generated by the pressure difference between the raw water pressure and the atmospheric pressure. However, as regard the low-pressure raw water, the suction force of the suction nozzles usually does not meet the requirement. After the filter is used for a long time, the filtering function of the filter is degraded obviously and the stability of the filter is poor. The suction pump disclosed in the present invention well addresses this defect. In practice, according to actual requirement such as the real-time monitored difference between the inner pressure and outer pressure of the fine strainer, the set pressure difference threshold, including factors such as the frequency generated by the case where the pressure difference threshold is exceeded, the power of the suction pump is manually or automatically adjusted to further adjust the suction pressure.

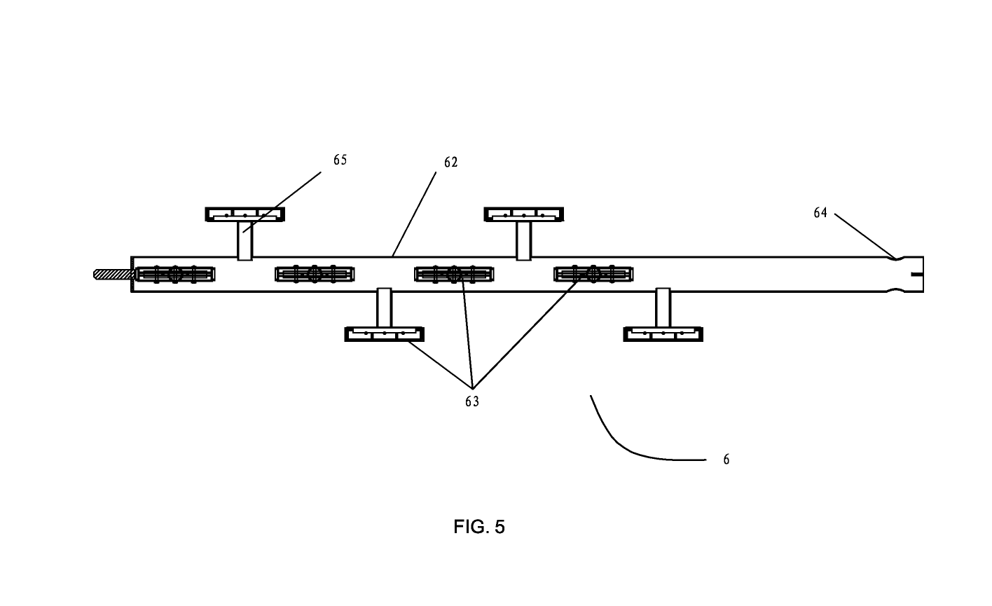

The sewage suction assembly 6 is driven by a rotation drive motor 7 in common mode such as driving the sewage suction assembly 6 by driving a transmission connection rod 71. The present invention additionally provides the suction pump, and thereby improves the difference between the inner pressure and outer pressure at the position of the suction nozzles. Therefore, the suction nozzles 63 may be arranged to oblong suction nozzles. As shown in FIG. 5, compared with the sharp suction nozzles in the prior art, the oblong suction nozzles 63 in the present invention has a larger suction area. Further, the suction pump also produces sufficient suction force, thereby meeting the suction requirement and creating a higher suction efficiency.

The suction nozzles are communicated with the sewage suction pipe 62 through a suction nozzle support rod 65. As shown in FIG. 5, the suction nozzle support rod forms a T-shape structure with the suction nozzles. The suction nozzles 63, as shown in FIG. 5, are arranged evenly and spacedly in a staggered manner from four different directions. The total length of the suction nozzles 63 is larger than that of the fine filter cavity 104. During operating of the filter, the sewage suction assembly is in rotation, each T-shape suction nozzle may be responsible for suctioning sewage in the cylinder area of the fine strainer having the length corresponding to the suction nozzle. When a plurality of T-shape suction nozzles are arranged spacedly, as long as blind areas are avoided according to the common mode, i.e., the shadows casted by the neighboring suction nozzles are not separated or interrupted from each other at the central axis of the fine strainer, after a round rotation of all the suction nozzles on the sewage suction assembly 6, the entire inner wall with meshes of the fine strainer is covered, and thorough backwashing is implemented for the fine strainer.

The suction nozzles are replaced with oblong suction nozzles, forming a T-shape structure with the nozzle support rod. Therefore, a transmission connection rod 71 may not like what is disclosed in the prior art as follows: the transmission connection rod must be in the screw rod structure, i.e., rotating while axially translating to drive the sewage suction assembly and the suction nozzles to suction the sewage and contaminants in linear scanning mode along the inner wall of the fine strainer. However, in the present invention, the transmission connection rod 71 only needs to implement the rotatable transmission function. The plurality of T-shape suction nozzles, after the sewage suction assembly rotates for a round, are capable of covering the entire inner wall of the fine strainer having meshes. In addition, the sewage suction assembly does not need to translate axially because the axial translation of the sewage suction assembly requires good liquid sealing performance of the filter. Further, the axial translation of the sewage suction assembly is either not required in the present invention. In this way, the overall structure of the filter is simpler, compact and more reliable and stable during operation, and the repair and maintenance are more convenient.

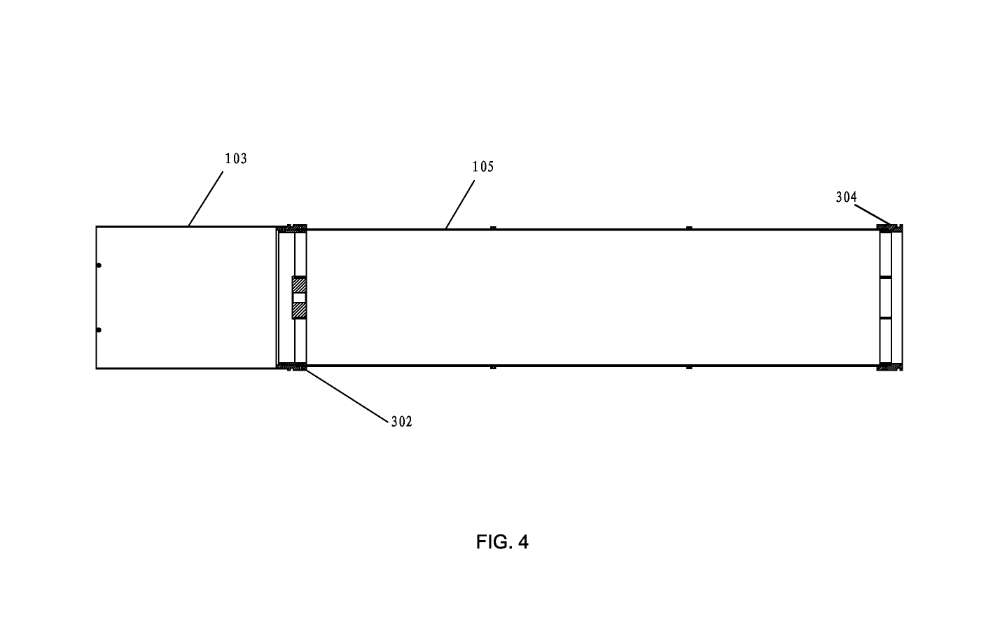

In the present invention, the sewage suction assembly 6 is driven in rotation mode for backwashing the filter. Therefore, the fine strainer 105 is preferably in a cylinder structure as shown in FIG. 4, and the sewage suction assembly 6 is arranged at the central axis of the cylinder fine strainer 105. It should be noted that other structures may also be applicable as long as they ensure that when the suction nozzles rotates to suction the sewage and contaminants on the inner wall of the fine strainer, the spacing between suction nozzles and the inner wall of the fine strainer is smaller without rubbing against each other during movement. In the present invention, the fine strainer is in a structure without end caps at the two ends, one end of the fine strainer is communicated with the coarse strainer. For convenience of making and installation, generally the coarse strainer and the fine strainer are connected to a whole to form a cylinder structure, which are supported and isolated by using a support jacket 302 of the fine strainer and an isolation plate 303 between the coarse and the fine filter cavities. However, this does not indicate that the coarse strainer or the fine strainer can be only in the cylinder structure.

One end of the fine strainer is communicated with the coarse strainer. The water preliminarily filtered by the coarse strainer is directly filtered again by the fine strainer. The other end of the fine strainer is communicated with the sand collection cavity 108. In specific embodiments of the present invention, the sand collection cavity 108 is arranged at the tail of the fine strainer. As shown in FIG. 2, the sand collection cavity is between the fine filter cavity and the sewage discharge cavity, and the sewage suction pipe still passes through the sand collection cavity and directly reaches the sewage discharge cavity. To be specific, based on the prior art, independent space is remained at the tail of the fine strainer to serve as the independently set sand collection cavity, and an isolation plate 304 between the coarse and fine filter cavities, as shown in FIG. 2, is used for support and isolation. It should be supplemented that in the specific embodiment illustrated in FIG. 2, the sewage discharge cavity and the coarse filter cavity are respectively arranged at the two ends of the fine strainer; therefore, the sand collection cavity 108 is between the fine strainer and the sewage discharge cavity. However, in practice, if the sewage discharge cavity and the coarse filter cavity are arranged at the same end of the fine strainer (in this case, it is required that the sewage suction assembly passes through the coarse filter cavity and is then led into the fine strainer); and the sand collection cavity 108 is not between the fine strainer and the sewage discharge cavity, but is opposite to the coarse filter cavity and the sewage discharge cavity and the coarse filter cavity are arranged at different ends of the fine strainer.

Referring to FIG. 2, the present invention provides a self-cleaning suction filter, whose working principles are as follows: a pressure difference switch 216 in a pressure difference apparatus arranged in the self-cleaning suction filter periodically detects the pressure difference between the inner pressure and the outer pressure of the fine strainer 105. When the pressure difference reaches or exceeds a preset threshold, an electrical control box 214 outputs control signals to start the rotation drive motor 7 to drive the sewage suction assembly 6 to rotate along the filter housing 203 or the central axis of the fine strainer 105. Meanwhile, the electrical control box 214 outputs control signals to start the suction pump 211, and the suction pump 211 starts pumping to enhance the relative negative pressure of the sewage discharge cavity 108. The suction nozzles 63 is communicated with the sewage discharge cavity 108 through the suction nozzle support rod 65 and the sewage suction pipe 62 by turn so that the suction nozzles 63 stays in the negative pressure state as compared with the inner and outer of the fine strainer. Then, the suction nozzles start to suction sewage, specifically, most mixture of water and swage and contaminants suctioned by the suction nozzles from the inner wall of the fine strainer pass through the suction nozzle support rod 65 and the sewage suction pipe 62, and reach the sewage discharge cavity, and pass through a suction pipe 209 and pumped out by the suction pump 211. In this way, simultaneous powerful sewage suction and discharge are implemented. With the progress of the sewage suction and discharge, the difference between the inner pressure and the outer pressure gradually decreases. When the difference between the inner pressure and the outer pressure of the fine strainer reaches a preset threshold, the electrical control box 214 outputs control signals to stop the rotation drive motor 7, and the sewage suction assembly stops action accordingly, switches off the water-power control valve suction pump 211. The suction pump 211 stops its suction function accordingly and repeats the above actions until the difference between the inner pressure and the outer pressure increases the preset threshold again. The above describes the process of backwashing the fine strainer in electrical control mode or automatic control mode. It should be noted that the manual control mode is also applicable. The mode for controlling the startup and stop of the backwashing process is not the key point of the present invention, which is thus not detailed herein. During the filtering process, the large-particle sewage and contaminants with the outer diameter larger than the spacing between the suction nozzles 63 and the meshes of the fine strainer 105 gradually settle down and are collected in the sand collection cavity 108 during filtering due to their own weight and the guiding force of the water flow. After a period of time, the sand discharge valve 109 may be switched on manually or electrically to directly discharge the sewage and contaminants having large particles collected in the sand collection cavity 108 from the sand discharge port.

In normal cases, to implement the above functions, the self-cleaning filter needs to be provided with an apparatus for the difference between the inner pressure and the outer pressure at proper time. When the difference reaches or exceeds a preset threshold, the electrical control unit outputs electrical signals. Upon the signals, the rotation drive motor 7 drives the sewage suction assembly 6 to translation spirally along the axial direction, a solenoid sewage discharge valve 11 is switched on, and the sewage suction assembly 6 starts working. Subsequently, the difference between the inner pressure and the outer pressure gradually decreases, the rotation drive motor 7 drives the sewage suction assembly 6 to restore and then stop action at a proper time accordingly, the solenoid sewage discharge valve 11 is switched off in case the normal filter efficiency of the circulating water is affected. The sewage suction assembly 6 acts again when the pressure difference increases to the preset threshold. The additional apparatuses are not related to the major objective of the present invention and thus are not detailed herein.

The self-cleaning suction filter has the following major characteristics:

1. When the water system pressure is communicated with the atmospheric pressure, the sewage discharge cavity 108 generates a relative negative pressure. In this way, the suction nozzles communicated with the sewage discharge cavity generates the suction force, to suction contaminants on the inner surface of the fine strainer.

2. The suction pump 211 is capable of enhancing the sewage suction ability of the suction nozzles 63 and the sewage discharge ability of the filter in the present invention; and adjusting the suction force generated by the suction pump 211 by using a common mode within the valid water raising capacity of the suction pump 211.

3. The suction nozzles suctions and cleans the surface of the fine strainer omnidirectionally, and meanwhile water bringing the sewage and contaminants from the outer surface of the fine strainer is also suctioned by the suction nozzles.

4. The large-particle sewage and contaminants with the outer diameter larger than the spacing between the suction nozzles and the meshes of the fine strainer gradually settle down and are collected in the sand collection cavity during filtering due to their own weight and the guiding force of the water flow. The sewage and contaminants may be discharged manually or automatically.

5. According to the present invention, the online backwashing apparatus of the self-cleaning suction filter consumes only a little water, and the water system is capable of working normally during the backwashing process, without affecting the normal filtering according to the present invention.

What is claimed is:

1. A self-cleaning suction filter, comprising a filter mechanism and a sewage suction assembly; wherein the filter mechanism comprises a water inlet, a coarse strainer, a coarse filter cavity, a fine filter cavity, a fine strainer, and a water outlet; wherein raw water is led in from the water inlet, flows through the coarse strainer into the coarse filter cavity, enters the fine filter cavity from the coarse filter cavity, and is led out from the water outlet after a secondary filter by the fine strainer; the sewage suction assembly is rotatably arranged at the center of the fine strainer and communicated with a sewage discharge cavity through a sewage suction pipe, and the sewage suction pipe is spacedly provided with a plurality of suction nozzles for suctioning deposits on the inner wall of the fine strainer; wherein the self-cleaning suction filter further comprises: a sand collection cavity arranged at the tail of the fine filter cavity and communicated with the fine filter cavity; and the coarse filter cavity, the fine filter cavity, and the sand collection cavity are descending in height.

2. The self-cleaning suction filter according to claim 1, further comprising: a suction pump; wherein the suction pump is arranged outside of the filter and the suction pipe of the suction pump is communicated with the sewage discharge cavity.

3. The self-cleaning suction filter according to claim 2, wherein a support for increasing the height is arranged at the bottom at one end of the filter closed to the coarse filter cavity.

4. The self-cleaning suction filter according to claim 3, wherein the sewage suction assembly rotates under the drive of a transmission rod driven by a rotation motor, the suction nozzles are oblong suction nozzles and communicated with the sewage suction pipe through a nozzle support rod, and the sum of the lengths of all suction nozzles is larger than the total length of the fine filter cavity.

5. The self-cleaning suction filter according to claim 4, wherein the fine strainer is a cylinder structure without end caps on the two ends, one end of the fine strainer is communicated with the coarse strainer, and the other end of the fine strainer is communicated with the sand collection cavity; wherein the sewage suction assembly is arranged at the central axis of the cylinder fine strainer.
